(19) United States
(12) Patent Application Publication
(10) Pub. No.: US 2007/0153704 A1
(43) Pub. Date: Jul. 5, 2007

(54) Traffic information providing apparatus and operating method using automatically scrolling display screen

(75) Inventors: Hyun-Suk Min, Suwon-si (KR); Kwang-Soo Kim, Seoul (KR); Jong-Hyun Kim, Suwon-si (KR); Jin-Won Kim, Seoul (KR); Sung-Chul Yang, Suwon-si (KR); Hye-Jung Yang, Busan-si (KR); Suk-In Jung, Seoul (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/606,232

(22) Filed: Nov. 29, 2006

(30) Foreign Application Priority Data
Jan. 4, 2006 (KR) 2006-0000988

(51) Int. Cl. H04L 12/26

(52) U.S. Cl. 370/252

(57) ABSTRACT

The present invention relates to a traffic information providing apparatus and an operating method. The method includes receiving real time traffic information, storing sectional traffic information, dividing screen information currently displayed on the display unit into unit areas, selecting the unit areas sequentially, detecting additional traffic information on the corresponding unit areas from the sectional traffic information stored in the step of storing according to information on the selection, and displaying the additional traffic information. Accordingly, the present invention aims to decrease the danger of traffic accidents and provides convenient selection of search location for real time traffic information to a user.

### PRIORITY

This application claims priority under 35 USC §119 to an application entitled “Traffic Information Providing Apparatus and Operating Method Using Automatically Scrolling Display Screen” filed in the Korean Industrial Property Office on Jan. 4, 2006 and assigned Serial No. 2006-0000988, the contents of which are incorporated herein by reference.

### BACKGROUND OF THE INVENTION

1. Field of the Invention

The present invention relates to a traffic information providing apparatus and an operating method, and more particularly, to a traffic information providing apparatus and an operating method using a traffic information display screen with automatic scrolling.

2. Description of the Prior Art

Recently, traffic congestion and accidents have increasingly occurred due to an increased number of drivers. As a result, various methods are being developed to provide real-time traffic information including traffic situations and accidents.

For example, real time traffic information providing methods currently known include providing traffic information by a presenter (for example, a reporter) in an FM broadcasting service, transmitting traffic broadcasting data by utilizing a channel for an FM broadcasting service, providing traffic information as an additional service of a mobile communication company, and providing traffic information by utilizing a digital multimedia broadcasting (DMB) service.

Of the above methods, the traffic information providing method utilizing a DMB service provides real time traffic information by utilizing data of the Transport Protocol Experts Group (hereinafter TPEG) protocol as a newer standard for transmitting information regarding traffic or travel. This method provides traffic information to a plurality of non-specified users using a DMB service by broadcasting the TPEG data including the real time information contained in DMB data.

For this purpose, a terminal capable of receiving the DMB data (hereinafter DMB terminal) is used to receive transmission of the real time traffic information included in the DMB data and to display the real time traffic information related to a location corresponding to information selected by a user.

In this case, the user must repeatedly operate the DMB terminal to select the location (i.e., search location) about which real time traffic information is to be provided. For example, the user must scroll a map to select the search location by using an input device such as buttons or a touch pad.

Although such a conventional method enables correct selection of a desired search location, the user must repeatedly operate the input device. Particularly, when receiving information on an overall traffic situation, the user must input selection information whenever the search location is changed, and may thereby experience inconvenience. Additionally, a user operating a vehicle can increase the risk of experiencing a traffic accident, because the user must operate the buttons or touch pad to select the search location while driving.

### SUMMARY OF THE INVENTION

In order to solve the above problems, an object of the present invention is to provide a traffic information providing apparatus and an operating method that can reduce the danger of traffic accidents by utilizing traffic information in real time.

Another object of the present invention is to provide a traffic information providing apparatus and an operating method that enable a user of real time traffic information to select a desired location conveniently.

Another object of the present invention is to provide a traffic information providing apparatus and an operating method that enable the user requesting real time traffic information to receive information on overall traffic situations more conveniently.

Another object of the present invention is to provide a traffic information providing apparatus and an operating method that provide real time traffic information on an area and route corresponding to the direction of movement of a car. Another object of the present invention is to provide a traffic information providing apparatus and an operating method that efficiently provide real time traffic information to a mobile terminal user.

In order to achieve the above objects, a traffic information providing apparatus of the present invention includes a display unit; a receiving unit receiving TPEG data including real time traffic information; a sectional traffic information management database detecting information on speeds and accidents in a minimum unit section of traffic information from the received TPEG data and storing sectional traffic information by utilizing the information on speeds and accidents; an automatic scroll control unit dividing screen information currently displayed on the display unit into unit areas for providing real time traffic information and sequentially selecting the unit areas, and a main control unit receiving information on the selected unit areas from the automatic scroll control unit, detecting additional traffic information on the corresponding unit areas in the sectional traffic information management database according to information on the selection, and outputting through the display unit.

The sectional traffic information management database preferably stores traffic information for the minimum unit section including average traveling speed, minimum traveling speed, estimated travel time, and accidents.

The main control unit preferably detects additional traffic information for the corresponding unit area on at least one among the average traveling speed, minimum traveling speed, estimated travel time, and accidents from the sectional traffic information management database.

Preferably, the traffic information providing apparatus further includes a sensing unit for detecting information on the current location and direction of forward movement of the traffic information providing apparatus and transmitting the detected information to the main control unit. Preferably, the automatic scroll control unit automatically scrolls a predetermined area adjacent to the current location in the direction of forward movement.

The main control unit preferably determines whether the traffic information providing apparatus is currently using a route guide service, and, if the traffic information providing apparatus is currently using a route guide service, transmits information on destination to the automatic scroll control unit. The automatic scroll control unit preferably receives the information on the current location and direction of forward movement of the traffic information providing apparatus from the main control unit and automatically scrolls the route from the current location to the destination.

In order to achieve the above objects, a traffic information providing method according to the present invention includes receiving TPEG data including real time traffic information; detecting information on speeds and accidents in a minimum unit section of traffic information from the received TPEG data and storing sectional traffic information by utilizing the information on speeds and accidents; dividing screen information currently displayed on the display unit into unit areas for providing real time traffic information, selecting the unit areas sequentially; detecting additional traffic information on the corresponding unit areas from the sectional traffic information stored in the step of storing according to information on the selection; and displaying the additional traffic information.

Preferably, the traffic information providing method further includes detecting information on user's current location and direction of forward movement, and deciding the range and direction of automatic screen scrolling according to the result of the detection.

Preferably, the predetermined area adjacent to the current location is automatically scrolled in the direction of forward movement in the step of decision.

Preferably, a destination included in the route guide service information is detected when the user uses a route guide service, and the route from the current location to the destination is automatically scrolled in the step of decision.

### BRIEF DESCRIPTION OF THE DRAWINGS

The above and other objects, features and advantages of the present invention will be more apparent from the following detailed description when taken in conjunction with the accompanying drawings, in which:

FIG. 1 is a schematic block diagram showing a traffic information providing apparatus automatically scrolling a traffic information display screen according to a first embodiment of the present invention;

FIGS. 2A to 2B are flow charts showing a traffic information providing method automatically scrolling a traffic information display screen according to the first embodiment of the present invention;

FIG. 3 is a schematic block diagram showing a traffic information providing apparatus automatically scrolling a traffic information display screen according to a second embodiment of the present invention;

FIG. 4 is a flow chart showing a traffic information providing method automatically scrolling a traffic information display screen according to the second embodiment of the present invention; and

FIGS. 5A to 5C are views of the traffic information display screen according to the first and second embodiments of the present invention.

### DETAILED DESCRIPTION OF THE PREFERRED EMBODIMENTS

Hereinafter, preferred embodiments of the present invention will be described in detail with reference to the accompanying drawings. The same reference numbers will be used for the same or like components in the accompanying drawings. Additionally, detailed explanations for well-known functions and compositions will be omitted for the sake of clarity and conciseness.

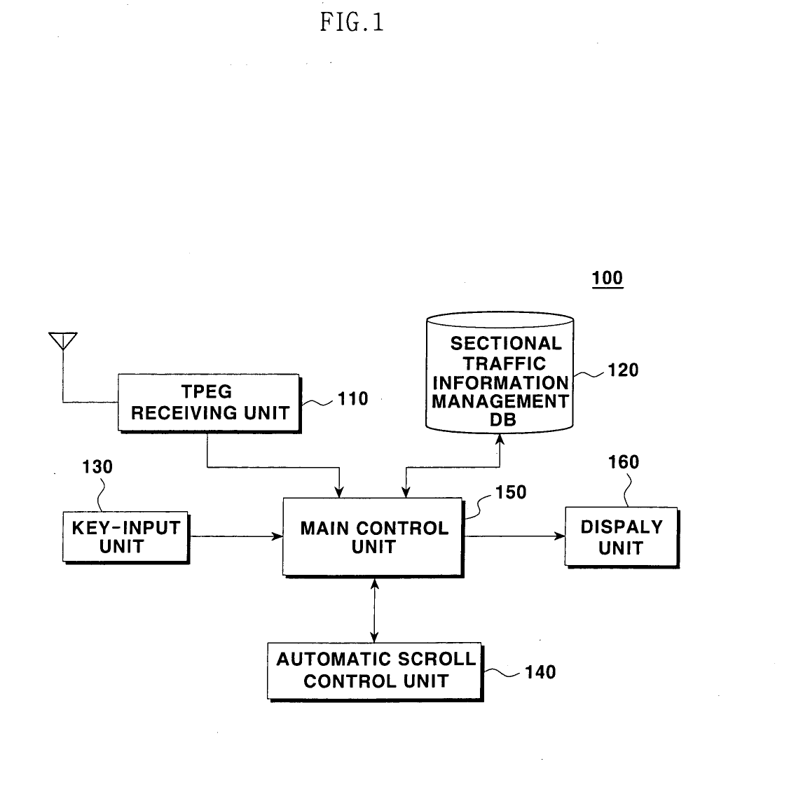

FIG. 1 is a schematic block diagram showing a traffic information providing apparatus automatically scrolling a traffic information display screen according to a first embodiment of the present invention. Referring to FIG. 1, the traffic information providing apparatus 100 includes a TPEG receiving unit 110, sectional traffic information management database (hereinafter DB) 120, key-input unit 130, automatic scroll control unit 140, main control unit 150 and display unit 160.

The TPEG receiving unit 110 receives TPEG data including real time traffic information. The TPEG receiving unit 110 preferably receives DMB data through a data network such as a DMB network and detects the TPEG data therefrom.

The sectional traffic information management DB 120 stores traffic information including sectional speeds and accidents. In particular, the sectional traffic information management DB 120 preferably receives information on sectional speeds and accidents that is obtained from TPEG data received from the TPEG receiving unit 110 from the main control unit 150, and generates and stores the sectional traffic information such as average traveling speed, minimum traveling speed, estimated travel time and accidents. The main control unit 150 preferably obtains the information on sectional speeds and accidents from the TPEG data, and stores the information in the sectional traffic information management DB 120. The section covered by the sectional traffic information management DB 120 is preferably a minimum unit section for providing real time traffic information.

The key-input unit 130 provides a user's interface for input of user's operation signal to control operation of the traffic information providing apparatus 100. Particularly, the key-input unit 130 preferably receives the user's operation signal to identify the traffic information and transmit it to the main control unit 150. For example, the key-input unit 130 preferably receives the user's operation signal for selecting a location (i.e. search location) to be served with real time traffic information from a traffic information display screen scrolling automatically, and transmits it to the main control unit 150.

The automatic scroll control unit 140 operates under the control of the main control unit 150, divides screen information (for example, a map) currently displayed on the display unit 160 into unit areas for providing real time traffic information, and selects the unit areas sequentially. The automatic scroll control unit 140 preferably divides the screen according to predetermined division information or according to division information input through the key-input unit 130. Additionally, the automatic scroll control unit 140 preferably selects the unit areas sequentially at time intervals according to the predetermined time information or information on the user's time selection.

The main control unit 150 controls operation of the traffic information providing apparatus 100 according to signals input through the key-input unit 130 or according to a pre-stored operation program. Particularly, the main control unit 150 controls the TPEG receiving unit 110 to receive TPEG data when the traffic information providing apparatus 100 operates in a DMB receiving mode.

Additionally, the main control unit 150 receives information on selecting the unit areas from the automatic scroll control unit 140 in real time and provides additional traffic information on the unit areas corresponding to information on the selection. The main control unit 150 preferably searches a sectional traffic information management DB 120 by utilizing identification information on the selected unit area, and detects additional traffic information on the corresponding area as a result.

Additionally, the main control unit 150 preferably receives selection information on the unit area sequentially selected in the automatic scroll control unit 140 in real time, and, if the user's operation signal for selecting an area to receive real time traffic information is input, detects the additional traffic information on the unit area by utilizing identification information on the unit area selected at the point of the operation signal input.

The detected additional traffic information is output through the display unit 160.

The display unit 160 displays an image signal under the control of the main control unit 150. Particularly, the display unit 160 displays information on selecting divided unit areas to provide real time traffic information. Further, additional traffic information on the corresponding unit area is displayed by receiving information from the main control unit 150 according to the user's selection.

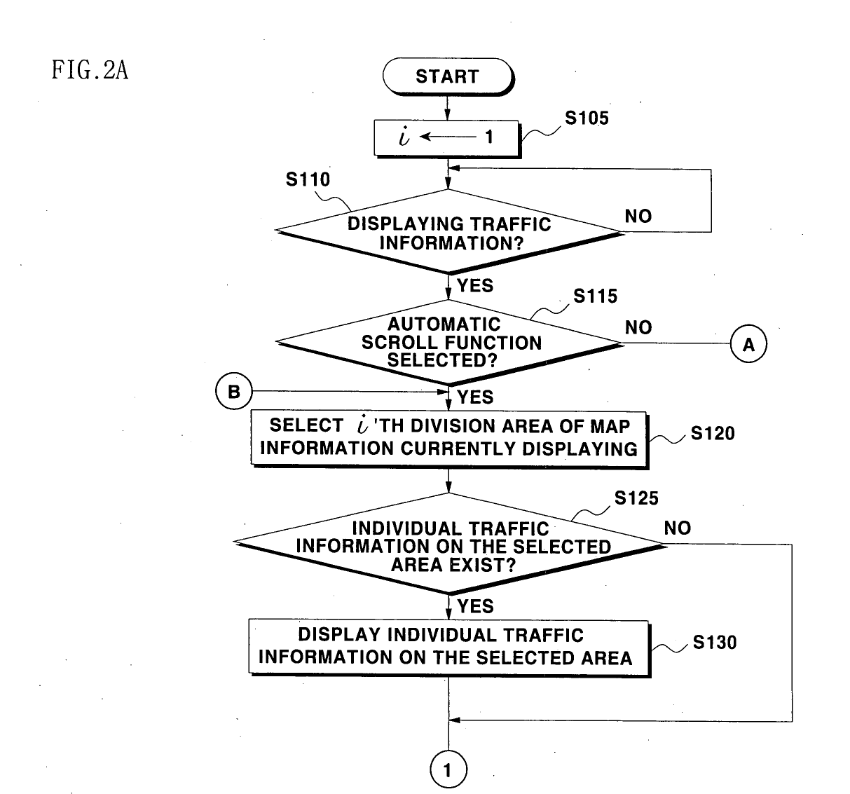

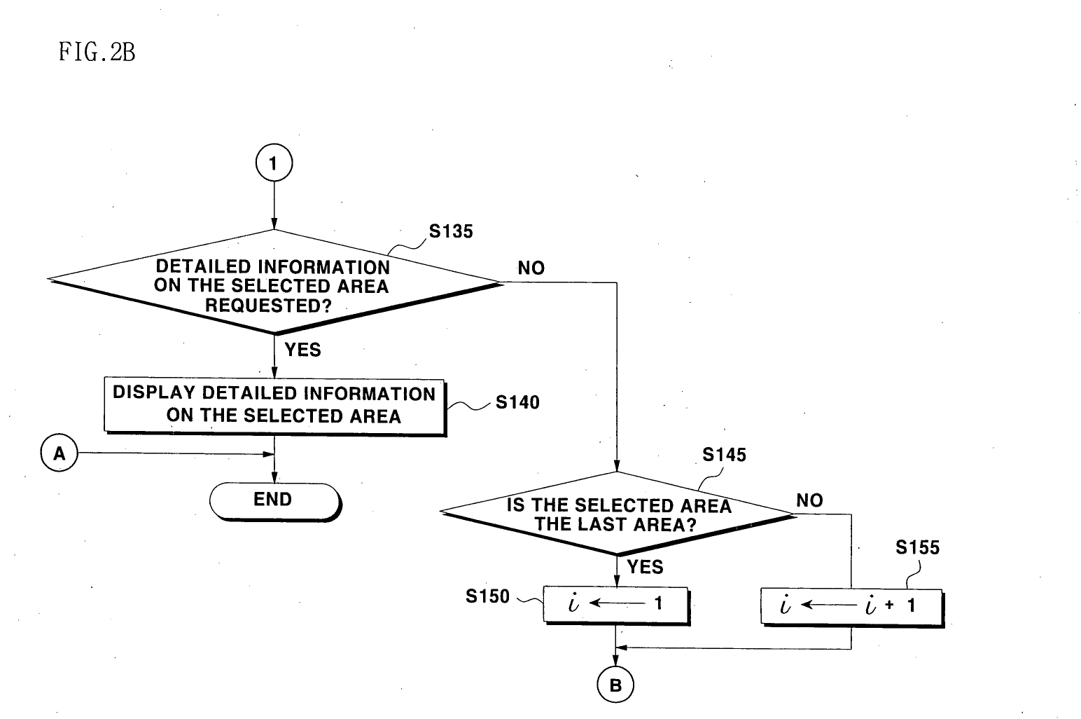

FIGS. 2A to 2B are flow charts showing a traffic information providing method automatically scrolling a traffic information display screen according to the first embodiment of the present invention.

Referring to FIGS. 1 and 2A to 2B, the automatic scroll control unit 140 initializes a variable ‘i’ required for automatic scrolling in step S105. For example, the variable ‘i’ is initialized to ‘1’. The variable ‘i’ is a value required to select a division area currently being displayed sequentially (for example, a unit area for providing real time traffic information). That is, the automatic scroll control unit 140 selects a subsequent division area by increasing the variable ‘i’.

Additionally, the main control unit 150 determines whether the display unit 160 is currently displaying traffic information in step S110. That is, the main control unit 150 determines whether the traffic information providing apparatus 100 is operating in a traffic information display mode.

As the result of step S110, if the display unit 160 is currently displaying traffic information, the main control unit 150 identifies whether an automatic scroll function is selected in step S115. This is for selective operation of the automatic scroll function. That is, the automatic scroll function is performed only when a user serviced with the traffic information selects the automatic scroll function.

As the result of step S115, if the automatic scroll function has been selected, the automatic scroll control unit 140 selects the ‘i’th division area in the information (for example, a map) currently being displayed in step S120. For example, the map currently being displayed is divided into ‘n’ areas and the ‘i’th division area is selected. In step S105, the value of ‘i’ has been initialized to ‘1’, and therefore the automatic scroll control unit 140 may select the first division area. Additionally, information on the division preferably uses a predetermined value or a value selected by the user. The speed of selecting the division area is preferably adjustable according to information on a predetermined time or information on the user's time selection. For example, the division areas are sequentially selected at the time intervals corresponding to the information on the predetermined time or information on the user's time selection.

Additionally, the main control unit 150 receives information on the selection and determines whether traffic information on the individually selected area exists in step S125. The main control unit 150 preferably searches a sectional traffic information management DB 120 by utilizing the information on the selection.

As the result of step S125, if traffic information on individually selected area exists, the main control unit 150 displays the traffic information on the individually selected area in step S130. In the event that the selected area is a section of a specific road, the traffic information on the individual section (for example, traveling speeds and accidents) is preferably detected from the sectional traffic information management DB 120 and displayed. Additionally, in the event that the selected area is a partial area of the whole map of an area, sections of roads included in the area are preferably searched and displayed after detecting the traffic information of individual road sections in the sectional traffic information management DB 120.

However, step S130 is omitted when traffic information on an individually selected area does not exist as the result of step S125.

Additionally, the main control unit 150 determines whether detailed information on the selected area is required in step S135. That is, the main control unit 150 determines whether detailed information on the selected area has been requested through the key-input unit 130.

As the result of step S135, if the detailed information on the selected area is requested, the main control unit 150 displays the detailed information on the selected area as a corresponding response in step S140. The main control unit 150 preferably searches the sectional traffic information management DB 120 and detects corresponding detailed information (for example, accidents).

As the result of step S135, if detailed information on the selected area has not been requested, the main control unit 150 determines whether the selected area is the last area among the division areas currently displayed on the display unit 160 in step S145.

As the result of step S145, if the selected area is the last area, the variable ‘i’ is set to ‘1’ and step S120 is performed to scroll again from the first area. On the other hand, as the result of step S145, if the selected area is not the last area, the variable ‘i’ is set to ‘i+1’ and step 120 is performed to select the next area after a predetermined time.

By performing such a process, the traffic information providing apparatus of the present invention has an advantage that a user can more easily confirm real time traffic information on a desired location by sequentially selecting/displaying a divided unit area (or a section) for providing real time traffic information.

Therefore, the present invention improves user convenience by automatically selecting/displaying the next area without a user's key operation to select a desired location for searching the real time traffic information.

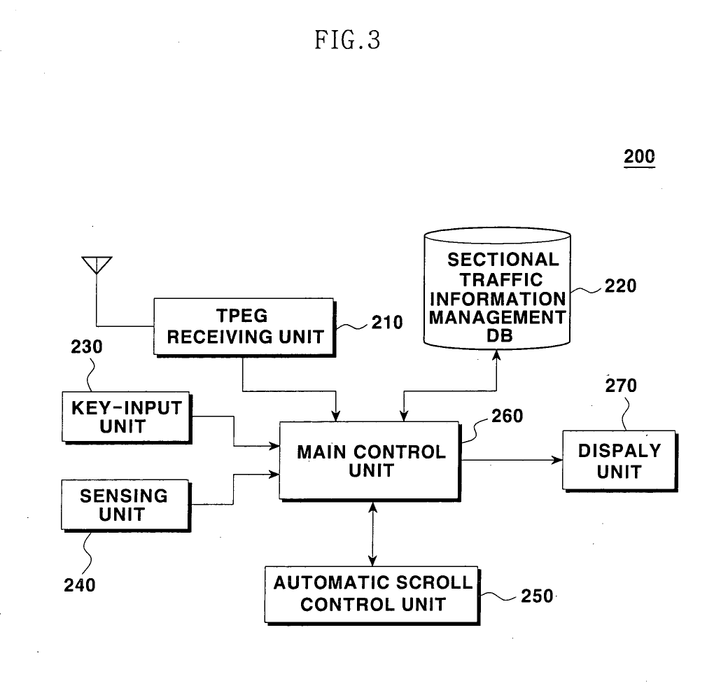

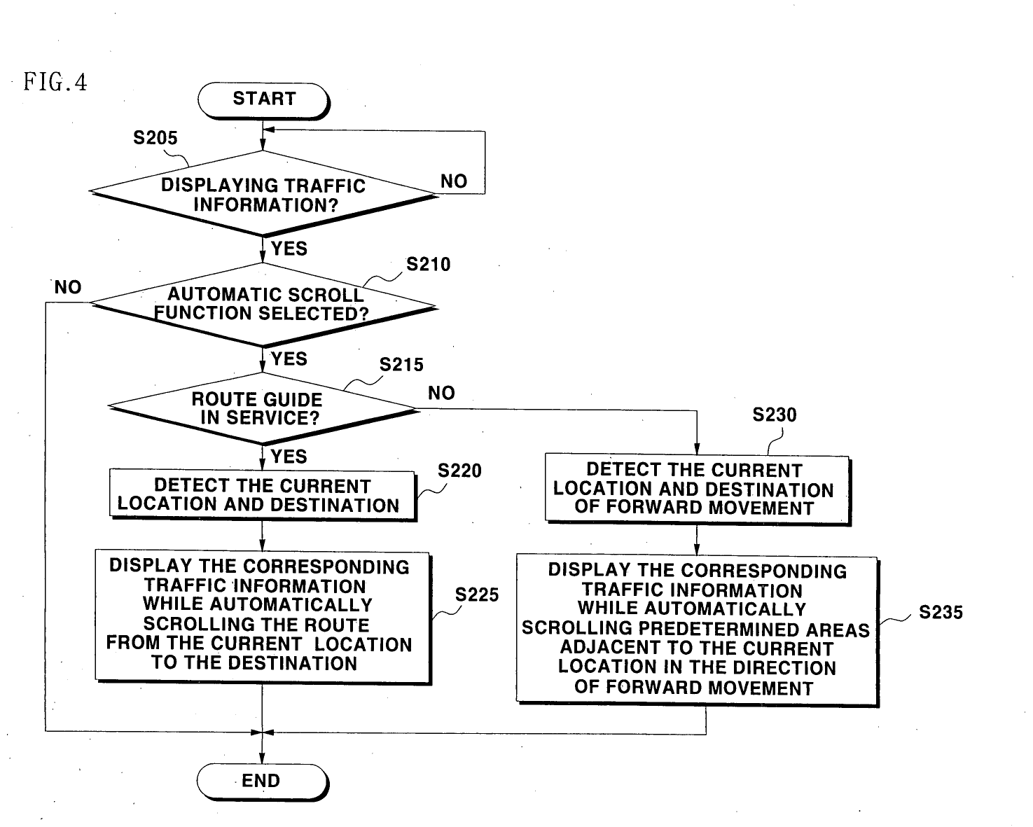

FIGS. 3 and 4 are drawings showing a traffic information providing apparatus and an operating method, respectively, automatically scrolling a traffic information display screen according to a second embodiment of the present invention, and illustrating a traffic information providing apparatus and an operating method detecting movement and direction of movement of the traffic information providing apparatus and automatically detecting/displaying the traffic information in that direction.

FIG. 3 is a schematic block diagram showing the traffic information providing apparatus. Referring to FIG. 3, the traffic information providing apparatus 200 comprises a TPEG receiving unit 210, sectional traffic information management DB 220, key-input unit 230, sensing unit 240, automatic scroll control unit 250, main control unit 260 and display unit 270.

The TPEG receiving unit 210 receives TPEG data including real time traffic information. The TPEG receiving unit 210 preferably receives DMB data through a data network such as a DMB network and detects the TPEG data therefrom.

The sectional traffic information management DB 220 stores traffic information including information on sectional speeds and accidents. Particularly, the sectional traffic information management DB 220 preferably receives information on sectional speeds and accidents that is obtained from TPEG data received from the TPEG receiving unit 210 from the main control unit 260, and generates/stores the sectional traffic information such as average traveling speed, minimum traveling speed, estimated travel time and accidents. The main control unit 260 preferably obtains the information on sectional speeds and accidents information from the TPEG data and stores the information in the sectional traffic information management DB 220. The section is preferably a minimum unit section for providing real time traffic information.

The key-input unit 230 provides a user's interface for input of the user's operation signal to control operation of the traffic information providing apparatus 200. In particular, the key-input unit 230 preferably receives the user's operation signal to identify the traffic information and transmits it to the main control unit 260. For example, the key-input unit 230 preferably receives the user's operation signal for selection of a location (i.e., search location) to be served with real time traffic information from a traffic information display screen scrolling automatically, and transmits it to the main control unit 260.

The sensing unit 240 detects information on the current location and direction of forward movement of the traffic information providing apparatus 200, and transmits it to the main control unit 260. The sensing unit 200 preferably includes a location detecting sensor (for example, a GPS sensor) and an inertial sensor (for example, an acceleration sensor). The purpose of detecting the current location and direction of forward movement of the traffic information providing apparatus 200 with the sensing unit 240 is to display the corresponding traffic information by automatically scrolling predetermined sections from the current location in the direction of forward movement.

The automatic scroll control unit 250 operates under the control of the main control unit 260, divides screen information (for example, a map) currently displayed on the display unit 270 into unit areas for providing real time traffic information, and selects the unit areas sequentially. The automatic scroll control unit 250 preferably divides the screen according to predetermined division information or according to division information input through the key-input unit 230.

The main control unit 260 controls operation of the traffic information providing apparatus 200 according to an input signal through the key-input unit 230 or according to a pre-stored operation program. Particularly, the main control unit 260 controls the TPEG receiving unit 210 to receive TPEG data when the traffic information providing apparatus 200 operates in a DMB receiving mode.

Additionally, the main control unit 260 receives information on selecting the unit areas from the automatic scroll control unit 250 in real time and provides additional traffic information on the corresponding unit areas according to information on the selection. The main control unit 260 preferably searches a sectional traffic information management DB 220 by utilizing identification information on the selected unit area, and detects additional traffic information on the corresponding area accordingly.

Additionally, the main control unit 260 receives information on the current location and direction of forward movement of the traffic information providing apparatus 200 from the sensing unit 240, and transmits it to the automatic scroll control unit 250, in order to decide the screen scroll direction of the automatic scroll control unit 250, and to scroll the traffic information display screen from the current location in the direction of forward movement.

Additionally, the main control unit 260 preferably receives selection information on the unit area sequentially selected in the automatic scroll control unit 250 in real time, and, if the user's operation signal for selecting an area to receive real time traffic information is input, detects the additional traffic information on the unit area by utilizing identification information on the unit area selected at the point of the operation signal input.

The detected additional traffic information is output through the display unit 270.

The display unit 270 displays an image signal under the control of the main control unit 260. Particularly, the display unit 270 displays information on selecting divided unit areas to provide real time traffic information. Further, additional traffic information on the corresponding unit area is displayed by receiving information from the main control unit 260 according to the user's selection.

FIG. 4 is a flow chart showing a traffic information providing method automatically scrolling a traffic information display screen according to the second embodiment of the present invention.

Referring to FIGS. 3 and 4, the main control unit 260 determines whether the display unit 270 is currently displaying traffic information, or in other words, currently operating in a traffic information display mode, in step S205.

As the result of step S205, if the display unit 270 is currently displaying traffic information, the main control unit 260 identifies whether an automatic scroll function is selected in step S210. This is for selective operation of the automatic scroll function. That is, the automatic scroll function is performed only when a user serviced with the traffic information selects the automatic scroll function.

As the result of step S210, if the automatic scroll function has been selected, the main control unit 260 determines whether the traffic information providing apparatus 200 is using a route guide service in step S215, and decides the range and direction of automatic scroll according to the result. That is, as the result of step S215, if the traffic information providing apparatus 200 is currently receiving a route guide service, the main control unit 260 detects information on the current location and destination for the route guide service in step S220, and displays the corresponding traffic information by automatically scrolling the route from the current location to the destination at predetermined time intervals in step S225. If however, as the result of step S215, the traffic information providing apparatus 200 is currently not receiving the route guide service, the main control unit 260 detects information on the current location and direction of forward movement of the traffic information providing apparatus 200 in step S230, and displays the corresponding traffic information by automatically scrolling a predetermined portion (for example, within several tens of meters) of the area adjacent to the current location in the direction of forward movement in step S235. The main control unit 260 preferably receives the information on the current location and direction of forward movement of the traffic information providing apparatus 200 from the sensing unit 240. Preferably, information on the destination of the traffic information providing apparatus 200 currently receiving the route guide service is stored separately in the main control unit 260.

The automatic scrolling of the steps S225 and S235 is preferably performed in the same manner as shown in FIGS. 2A to 2B. For example, real time traffic information on the corresponding area is preferably provided by dividing the entire area for scrolling into division areas for real time traffic information service, and sequentially selecting the division areas.

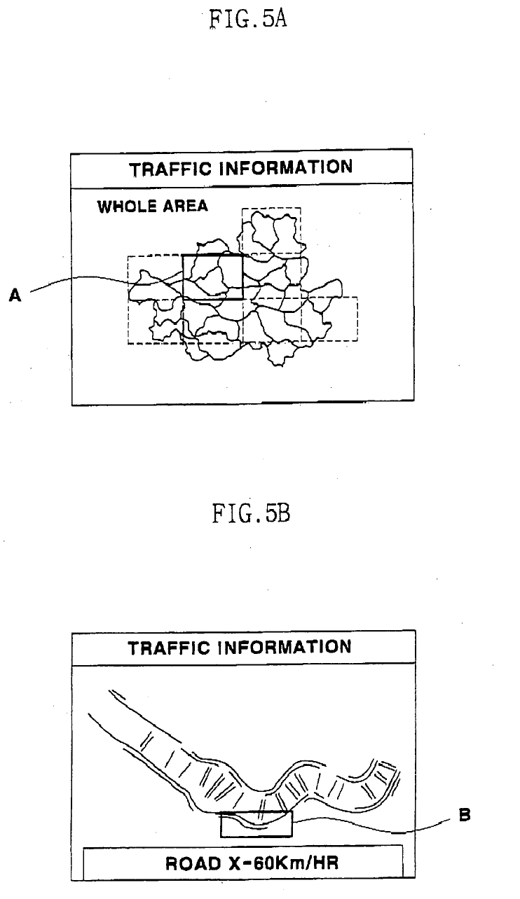

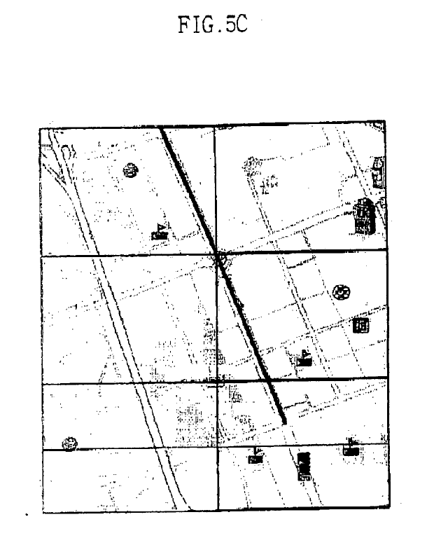

FIGS. 5A to 5C are views showing examples of the traffic information display screen according to the first and second embodiments of the present invention.

FIG. 5A is a view showing an example of dividing a map of the whole area of a city for providing traffic information on the city and automatically scrolling the division areas. That is, FIG. 5A is an example of dividing the whole area of the city into 8 areas and automatically scrolling the 8 areas, wherein an area ‘A’ is selected. If, as shown in FIG. 5A, a user requests detailed information on an area by selecting with a ‘confirm’ key in the state in which the area ‘A’ is selected, the traffic information providing apparatus of the present invention displays detailed information (for example, a detailed map, average speed, and minimum speed in a section) of the area ‘A’. The traffic information providing apparatus of the present invention preferably highlights or blinks the area ‘A’. If, however, there is no user's input of the confirmation in the state in which the area ‘A’ is selected, the traffic information providing apparatus preferably displays the next area by automatically scrolling, and waits for the user's input.

FIG. 5B is a view showing an example of displaying simplified traffic information on the corresponding area while automatically scrolling sections of a specific road to provide traffic information on the city. Particularly, FIG. 5B shows an example of displaying the simplified traffic information on the corresponding area while automatically scrolling pre-sorted sections of the Road X for real time traffic information service. Referring to FIG. 5B, a section ‘B’ of Road X shows 60 Km/hr of average traveling speed or minimum traveling speed. The simplified traffic information is preferably stored in the sectional traffic information management DBs 120 and 220 of FIGS. 1 and 3, respectively.

FIG. 5C shows an example of automatically scrolling a detailed map of a specific area. That is, FIG. 5C shows an example in which the corresponding simplified traffic information is displayed by automatically scrolling predetermined unit areas of the detailed map.

As described above, the present invention provides convenience to a user by automatically changing the sections with the automatic scroll and displaying the simplified traffic information accordingly.

The present invention enables a user to receive real time traffic information on the overall traffic situations more conveniently, and therefore has an advantage of reducing the danger of traffic accidents. Particularly, the present invention provides a user with convenient selection of a search location of real time traffic information by performing an automatic scroll function, selecting predetermined division areas sequentially, and providing efficient real time traffic information.

Although preferred embodiments of the present invention have been described in detail herein, it should be understood that many variations and/or modifications of the basic inventive concept herein described, which may appear to those skilled in the art, will still fall within the spirit and scope of the present invention as defined in the appended claims.

What is claimed is:

1. A traffic information providing apparatus comprising:
a display unit;
a receiving unit for receiving real time traffic information;
a sectional traffic information management database for detecting information on speeds and accidents in a minimum unit section of traffic information from the received real time traffic information and storing sectional traffic information by utilizing the information on speeds and accidents;
an automatic scroll control unit for dividing screen information currently displayed on the display unit into unit areas for providing real time traffic information and sequentially selecting the unit areas; and
a main control unit for receiving information on the selected unit area from the automatic scroll control unit, detecting additional traffic information on the corresponding unit areas in the sectional traffic information management database according to the information on selection, and outputting traffic information through the display unit.

2. The traffic information providing apparatus of claim 1, wherein the receiving unit receives real time traffic information expressed as Transport Protocol Experts Group (TPEG) data of a TPEG protocol.

3. The traffic information providing apparatus of claim 2, wherein the receiving unit detects the TPEG data from digital multimedia broadcasting (DMB) data after receiving the DMB data including the TPEG data through a DMB network.

4. The traffic information providing apparatus of claim 1, wherein the sectional traffic information management database stores traffic information for the minimum unit section including average traveling speed, minimum traveling speed, estimated travel time, and accidents.

5. The traffic information providing apparatus of claim 4, wherein the main control unit detects additional traffic information for the corresponding unit areas on at least one of the average traveling speed, minimum traveling speed, estimated travel time, and accidents from the sectional traffic information management database.

6. The traffic information providing apparatus of claim 1, wherein the automatic scroll control unit divides the screen information according to predetermined screen division information.

7. The traffic information providing apparatus of claim 1, wherein the automatic scroll control unit divides the screen information according to information on a user's selection.

8. The traffic information providing apparatus of claim 1, wherein the automatic scroll control unit sequentially selects the unit areas at time intervals according to predetermined time information.

9. The traffic information providing apparatus of claim 1, wherein the automatic scroll control unit sequentially selects the unit areas at time intervals according to information on a user's time selection.

10. The traffic information providing apparatus of claim 1, further including a sensing unit detecting information on a current location and direction of forward movement of the traffic information providing apparatus and transmitting the detected information to the main control unit.

11. The traffic information providing apparatus of claim 10, wherein the sensing unit includes a global positioning system (GPS) sensor for detecting the current location of the traffic information providing apparatus; and
an inertial sensor for detecting the direction of forward movement of the traffic information providing apparatus.

12. The traffic information providing apparatus of claim 10, wherein the automatic scroll control unit receives the information on the current location and direction of forward movement of the traffic information providing apparatus from the main control unit and automatically scrolls a predetermined area adjacent to the current location in the direction of forward movement of the traffic information providing apparatus.

13. The traffic information providing apparatus of claim 10, wherein the main control unit determines whether the traffic information providing apparatus is currently using a route guide service, and, if the traffic information providing apparatus is currently using the route guide service, transmits information on a destination to the automatic scroll control unit.

14. The traffic information providing apparatus of claim 13, wherein the automatic scroll control unit receives the information on the current location and direction of forward movement of the traffic information providing apparatus from the main control unit and automatically scrolls the route from the current location to the destination.

15. The traffic information providing apparatus of claim 1, wherein the traffic information providing apparatus is a mobile communication terminal.

16. A traffic information providing method, comprising the steps of:
receiving real time traffic information;
detecting information on speeds and accidents in a minimum unit section of traffic information from the received real time traffic information and storing sectional traffic information by utilizing the information on speeds and accidents;
dividing screen information currently displayed on a display unit into unit areas for providing real time traffic information;
selecting the unit areas sequentially;
detecting additional traffic information on the corresponding unit areas from the sectional traffic information stored in the step of storing according to information on the selection; and
displaying the additional traffic information.

17. The traffic information providing method of claim 16, wherein the real time traffic information expressed as Transport Protocol Experts Group (TPEG) data of a TPEG protocol.

18. The traffic information providing method of claim 17, wherein the TPEG data is detected from digital multimedia broadcasting (DMB) data after the DMB data including the TPEG data is received through a DMB network.

19. The traffic information providing method of claim 16, wherein the traffic information for the minimum unit section including an average traveling speed, minimum traveling speed, estimated travel time, and accidents is stored.

20. The traffic information providing method of claim 16, wherein the screen information is divided according to predetermined screen division information.

21. The traffic information providing method of claim 16, wherein the screen information is divided according to information on a user's selection.

22. The traffic information providing method of claim 16, wherein the unit areas are sequentially selected at time intervals according to predetermined time information.

23. The traffic information providing method of claim 16, wherein the unit areas are sequentially selected at time intervals according to information on a user's time selection.

24. The traffic information providing method of claim 16, further comprising:
detecting information on a user's current location and direction of forward movement; and
deciding a range and direction of automatic screen scrolling according to a result of the detection.

25. The traffic information providing method of claim 24, wherein the predetermined area adjacent to the current location is automatically scrolled in a direction of forward movement.

26. The traffic information providing method of claim 24, wherein destination included in the route guide service information is detected when the user uses a route guide service, and the route from the current location to the destination is automatically scrolled.
